(19) United States
(12) Patent Application Publication
(10) Pub. No.: US 2023/0289895 A1
(43) Pub. Date: Sep. 14, 2023

(54) DOUBLE BLIND OPT IN SOCIAL NETWORK AND INTERFACE

(71) Applicant: Meet Muse Media Inc., Vancouver (CA)

(72) Inventor: Kimberly Reid Kaplan, Vancouver (CA)

(73) Assignee: Meet Muse Media Inc., Vancouver (CA)

(21) Appl. No.: 17/654,049

(22) Filed: Mar. 8, 2022

(51) Int. Cl. G06Q 50/00

(52) U.S. Cl. CPC G06Q 50/01

(57) ABSTRACT

Systems and methods for educational analysis optimization. The system includes a camera, a processor and memory. The memory stores instructions to execute a method. The method begins with receiving a request from a user at a client device to begin a stimulus session. Then, video recording of the user for the stimulus session is initialized. Next, calibrations for emotions and gaze are set. Then, one or more stimuli are presented to the user. Cues and reactions are recorded and mapped to content that was displayed during the times of recorded reactions and cues. The recordings are post-processed for educational analysis and feedback is provided to the user. The feedback and analysis can be optimized using a predictive artificial intelligence model.

### CROSS-REFERENCE TO RELATED APPLICATIONS

This application claims the benefit of prior application U.S. Provisional Application No. 63/135,408, filed Jan. 08, 2021, titled “DOUBLE BLIND OPT IN SOCIAL NETWORK AND INTERFACE” by Kimberly Kaplan, which is herein incorporated by reference in its entirety for all purposes.

### TECHNICAL FIELD

The present disclosure relates to the field of computer systems, and specifically to social networks.

### BACKGROUND

Social media is becoming more and more pervasive in society. In most social networks, one can add to their network by requesting and confirming requests for friends or matches. Most social networks require a user to specifically request to connect with another user, or the user has to make their profile available to everybody to see their content. This is a problem because if the user wants their profile to be public in order for certain people to be able to discover them, then unwanted strangers can also message the user randomly, or request to connect, without the need for consent. This can lead to inundation with unsolicited and/or undesired messages and or connection requests, which can discourage users from engaging in the social media and also bury requests from people with whom the users actually want to connect. Thus, there is a need for a social media platform that allows users to share their information publicly and yet not be cluttered with unsolicited messaging and connection requests.

### SUMMARY

The following presents a simplified summary of the disclosure in order to provide a basic understanding of certain embodiments of the present disclosure. This summary is not an extensive overview of the disclosure and it does not identify key/critical elements of the present disclosure or delineate the scope of the present disclosure. Its sole purpose is to present some concepts disclosed herein in a simplified form as a prelude to the more detailed description that is presented later.

Aspects of the present disclosure relate to systems, methods, and non-transitory computer readable media. The method includes determining, by a social network application, a potential match between a first user and a second user. The method also includes displaying content from the first user to the second user and content from the second user to the first user. Displaying content includes inserting the content into a content feed of a user. The method also includes receiving in a graphical user interface of the social network application a request by the first user to opt in to communicate with the second user. The method also includes storing the request by the first user in a database such that the second user is not notified about, and cannot see, the request by the first user. The method also includes recording a match only if the second user independently requests to opt in to communicate with the first user without knowing that the first user has also requested to communicate with the second user. The first user also is not notified if the second user opts in to communicate with the first user before the first user opts in to communicate with the second user. The method also includes creating a communication channel between the first user and the second user via the graphical user interface. The communication channel is not created until after both the first user and the second user opt in to communicate with each other.

In some embodiments, the request by the first user or the request by the second user includes a pre-match message, the pre-match message being stored in a separate database and displayed in the communication channel only if a match is recorded. In some embodiments, both the first and second user uploads video content to be shown in other users’ feeds. In some embodiments, any content uploaded or messages sent are moderated before being displayed. In some embodiments, a particular user’s content feed includes content of other users that have opted in to communicate with that particular user but the particular user is not notified and cannot see who has opted in to communicate with the particular user. In some embodiments, a request to opt in is correlated with a certain piece of video content, and after a match is a recorded, the certain piece of content is automatically uploaded into the communication channel. In some embodiments, a user’s feed is filtered by preferences of the user.

Additional advantages and novel features of these aspects will be set forth in part in the description that follows, and in part will become more apparent to those skilled in the art upon examination of the following or upon learning by practice of the disclosure.

### BRIEF DESCRIPTION OF DRAWINGS

The disclosure may best be understood by reference to the following description taken in conjunction with the accompanying drawings, which illustrate particular embodiments of the present disclosure. In the description that follows, like parts are marked throughout the specification and drawings with the same numerals, respectively. The drawing figures are not necessarily drawn to scale and certain figures may be shown in exaggerated or generalized form in the interest of clarity and conciseness.

FIG. 1 shows a diagram of a system, in accordance with one or more embodiments of the present disclosure.

FIG. 2 shows a flowchart, in accordance with one or more embodiments of the present disclosure.

FIG. 3A, FIG. 3B, FIG. 3C, FIG. 3D, FIG. 3E, FIG. 3F, FIG. 3G, FIG. 3H, FIG. 3I, FIG. 3J, FIG. 3K, FIG. 3L, FIG. 3M, FIG. 3N, FIG. 3O, FIG. 3P, FIG. 3Q, and FIG. 3R show a series of screenshots of the graphical user interface, in accordance with one or more embodiments of the present disclosure.

FIG. 4A and FIG. 4B shows a computing system, in accordance with one or more embodiments of the present disclosure.

FIG. 5 is a flow diagram illustrating an example flow of system operations, in accordance with embodiments of the present disclosure.

FIG. 6 shows one example of a system architecture, in accordance with embodiments of the present disclosure.

FIG. 7 shows one example of a software architecture system, in accordance with embodiments of the present disclosure.

### DETAILED DESCRIPTION

Reference will now be made in detail to some specific examples of the disclosure including the best modes contemplated by the inventors for carrying out the disclosure. Examples of these specific embodiments are illustrated in the accompanying drawings. While the disclosure is described in conjunction with these specific embodiments, it will be understood that it is not intended to limit the disclosure to the described embodiments. On the contrary, it is intended to cover alternatives, modifications, and equivalents as may be included within the spirit and scope of the disclosure as defined by the appended claims.

For example, the techniques of the present disclosure will be described in the context of biometric monitoring and education analysis optimization. However, it should be noted that the techniques of the present disclosure apply to a wide variety of network transactions, collaborative environments, data structures, and different types of data. In the following description, numerous specific details are set forth in order to provide a thorough understanding of the present disclosure. Particular example embodiments of the present disclosure may be implemented without some or all of these specific details. In other instances, well known process operations have not been described in detail in order not to unnecessarily obscure the present disclosure.

Various techniques and mechanisms of the present disclosure will sometimes be described in singular form for clarity. However, it should be noted that some embodiments include multiple iterations of a technique or multiple instantiations of a mechanism unless noted otherwise. For example, a system uses a processor in a variety of contexts. However, it will be appreciated that a system can use multiple processors while remaining within the scope of the present disclosure unless otherwise noted. Furthermore, the techniques and mechanisms of the present disclosure will sometimes describe a connection between two entities. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments are directed to a double blind opt in social network and interface. A social network is a network of users that connects users to each other for the purposes of communication. The social network is generated by a social network computing system. Namely, the social network computing system provides the hardware and software structures for the social network to function. For example, a social network may be a dating network, a friendship network, a professional network, and/or another type of social network.

Exhibit A is a presentation entitled “Double Blind Opt In” describing one or more embodiments of the present disclosure. Exhibit A is incorporated herein by reference in its entirety.

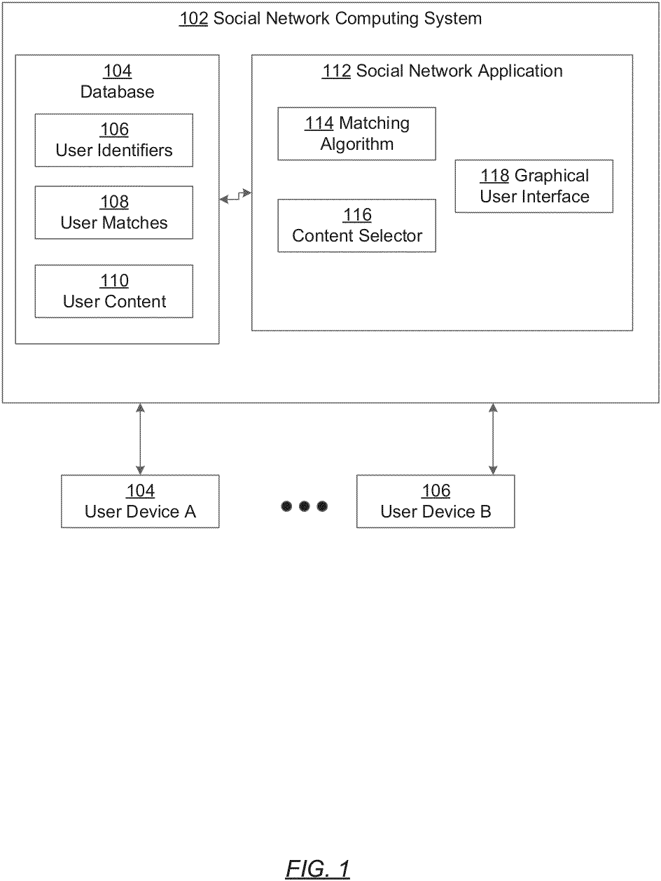

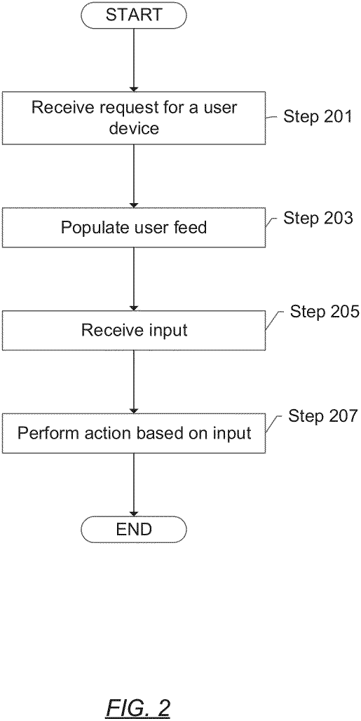

FIG. 1 shows a diagram of a system in accordance with one or more embodiments. As shown in FIG. 1, the system includes a social network computing system (102) connected to user devices (e.g., user device A (104), user device B (106)). The social network computing system may be the computing system discussed below and in FIG. 4A and FIG. 4B.

The user devices are computing devices connected to the social network computing system. For example, the user devices may be the computing system FIG. 4A and FIG. 4B as related to personal computing devices. Example user devices include laptop computers, desktop computers, tablets, mobile phones, and other such devices.

The social network computing system (102) includes a database (104) with user identifiers (106), user matches (108), and user content (110). The user identifiers include, for each user, a unique identifier assigned to the user that uniquely identifies the user from amongst the other users of the system. User matches are connections between users. Each user match is a stored connection between two users. Stated another way, the user match is a stored authorization credential by a user to present the user’s content and allow a communication to the user. In one or more embodiments, a user match may be single directional or bidirectional. A single directional match is a match that is only opted into by one of the users. In the database, a single directional match may be a stored value indicating that a first user identifier has opted into a match with a second user identifier. A bidirectional match may be a single different stored value or two stored values indicating that both users have opted into the match with each other. In one or more embodiments, communication is only authorized by the social network for bidirectional matches. Namely, the social network allows the communication only for bi-directional matches. In some embodiments, content marked as private may be allowed only for bi-directional matches. Specifically, in such embodiments, the posting user may mark the content as private, which provides the content only to bi-directional matches.

User content (110) is any content provided by a user to be a post for presentation to other users. For example, user content (110) may include images, audio, and/or video content. Examples of user content include videos that the user created and other such content. User content (110) may include private content and public content. Public content is content that is accessible to any user. For example, public content may be content that the user puts forth as an introduction to other user or other content that the user wants to share with potential matches, single directional matches, and bidirectional matches. Private content is content that is transmitted to other users for which a bi-directional match exists between the user and the other users. Namely, private content is user content that is authorized for a user’s bidirectional matches to receive.

For each user, the database (104) relates a unique user identifier to various administrative information about the user (e.g., login information, name, email address, location, as well as information about interests, hobbies, activities, and other information that may be used to determine matches). The database (104) further relates the user identifier to user matches of the user and user content. The database (104) may further store other information for the user including messages.

A social network application (112) is connected to the database (104). The social network application (112) provides the software implementation of the social network. The social network application (112) includes a matching algorithm (114), a content selector (116), and a graphical user interface (118). In one or more embodiments, the matching algorithm (114) is a software algorithm that determines whether to propose a match between two users.

The content selector (116) is configured to select user content from other users to post in a user’s feed. The content selector may further be configured to define an ordering of the user content. For example, the ordering may be based on time and/or a priority assigned to the matches.

The graphical user interface (118) is an interface for presenting a user feed, opting into matches, receiving user posts, and interacting with posts for sending replies and messages. The graphical user interface (118) is configured for display on the display of the user device. In one or more embodiments, the graphical user interface is configured to display a user feed to the user. The user feed includes a series of posts from different users. Each post in the user feed may be public content or private content. Posts in the user feed may be intermixed from different users. Posts may further be ordered and selected by the content selector. In some embodiments, each post is displayed on a full screen of the user device (e.g., in a mobile version). User’s may scroll through the posts. In some embodiments, one or more posts may be part of a display screen (e.g., in a non-mobile version). In one or more embodiments, users are only able to see proposed matches (proposed by the matching algorithm), single directional matches, and bidirectional matches in the graphical user interface.

Although not shown in FIG. 1, all or part of the social network application may be executed on the user device.

Turning to FIG. 2, FIG. 2 shows a flowchart in accordance with one or more embodiments. In Step 201, a request from the user device is received for a batch of matches and user posts. The request may be received from the user device as a request for a user feed.

In Step 203, the content selector using the matching algorithm and database selects content to populate into the user feed. The graphical user interface formats the various content within the feed and adds control widgets. The graphical user interface displays the feed to the user. For non-matches (e.g., proposed matches), the user is blind as to whether the other user has opted into the match. Further, users do not invite other users. Thus, in one or more embodiments, the matching algorithm is the sole determinator of whether to propose a match between two users. If a match is proposed, neither user is aware of whether the other user has opted into the match until after both users opt in. The fact that neither user is allowed communication unless the match is bidirectional and the fact that users cannot propose a match makes the social network a double blind opt in social network.

In other words, the match is proposed to both users in a timeframe determined by the matching algorithm. Generating the match does not require additional input from one of the users to propose to the other user. Moreover, neither user is aware of the other user opting in at the time of presenting the match. Opting into a match by both users create a bidirectional match.

In Step 205, input is received from the user. The user may interact with the graphical user interface widgets displayed in the user’s feed.

In Step 207, an action is performed based on the user input. For example, if the user opts into a match, and the match is already opted into by the other user, then a celebration indicator may be displayed in the user’s feed. Further, additional graphical user interface widgets may be displayed on the user’s posts. For example, the additional widgets may be to send direct messages (DMs), videos, voice and perform other actions. In some embodiments, the action may further include updating the other user’s feed with the user’s private content. Other actions may be performed without departing from the scope of the present disclosure.

The operations of FIG. 2 may be continually repeated as users interact with the system.

The following example is for explanatory purposes only and not intended to limit the scope of the present disclosure. In the example, personal information including pictures of people, names, and location is covered to maintain privacy of individuals. In the graphical user interface, such information is not covered.

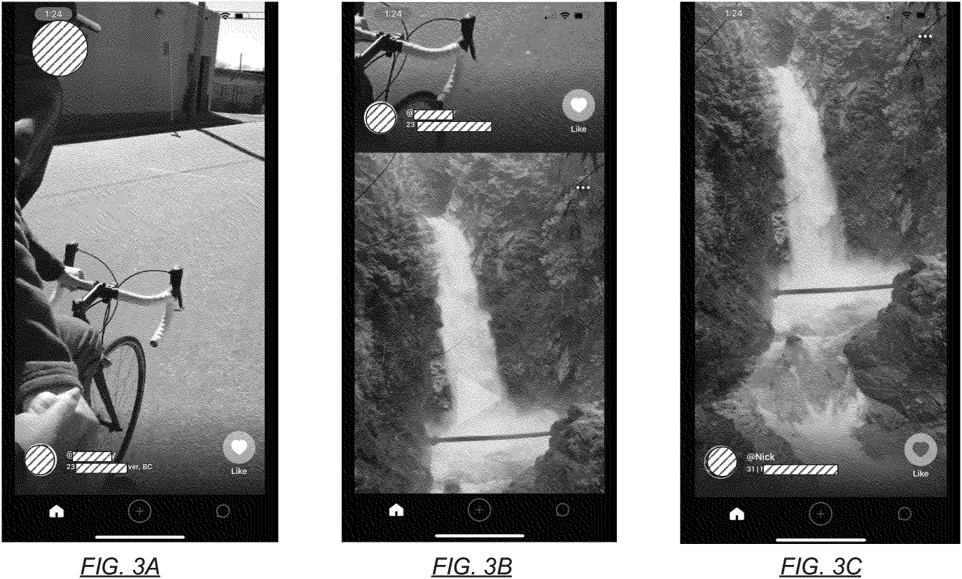

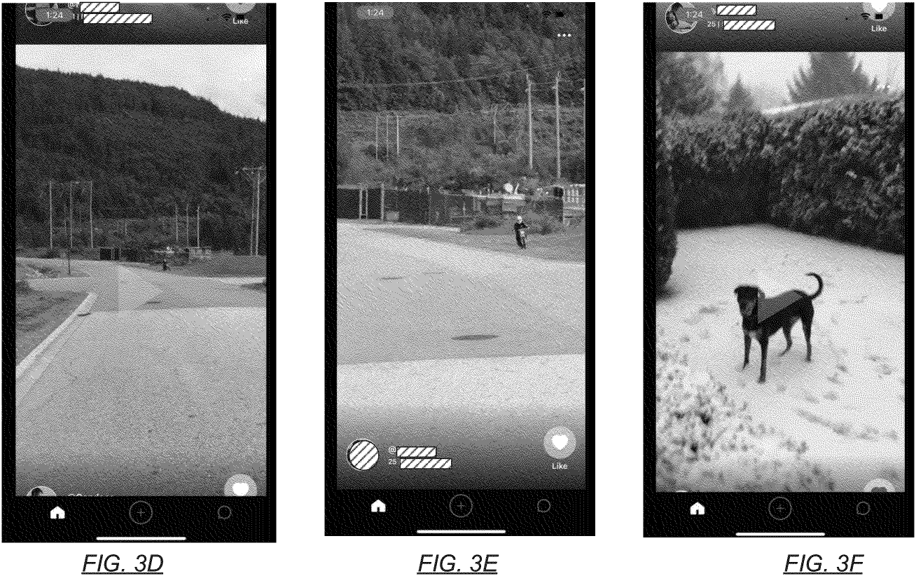

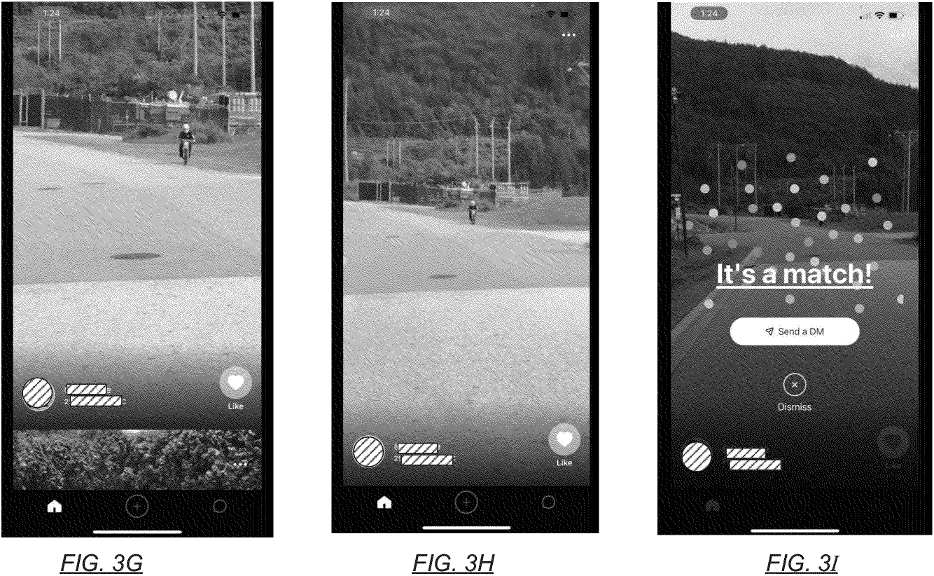

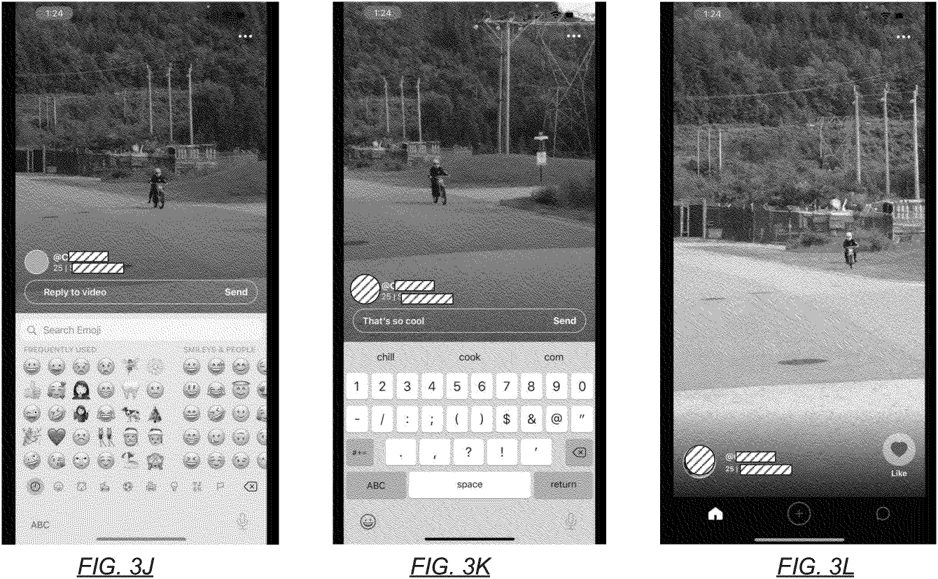

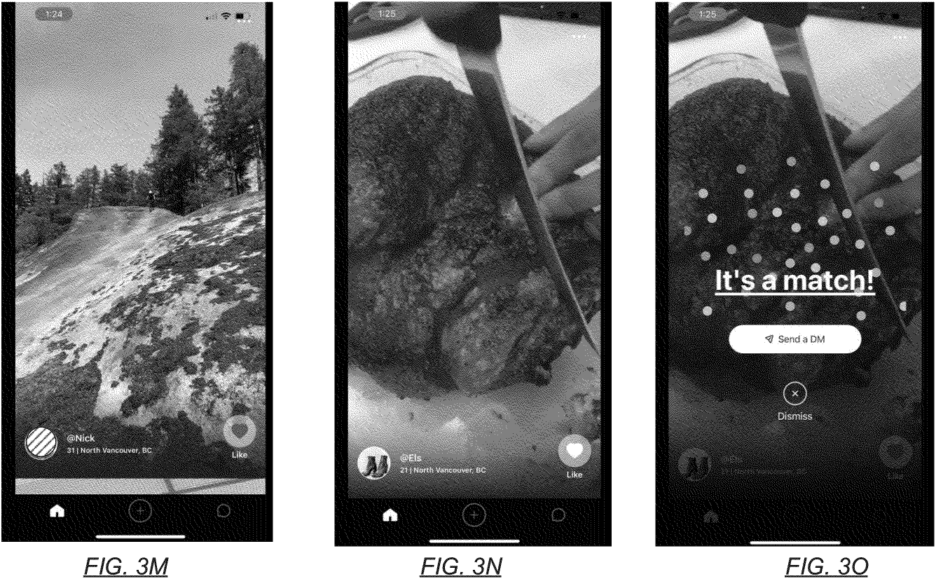

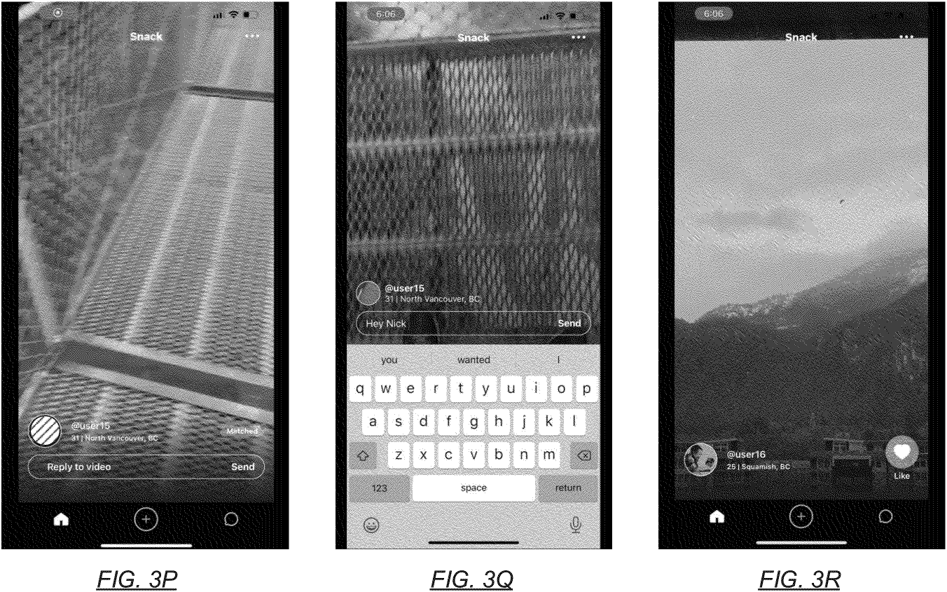

FIG. 3A, FIG. 3B, FIG. 3C, FIG. 3D, FIG. 3E, FIG. 3F, FIG. 3G, FIG. 3H, FIG. 3I, FIG. 3J, FIG. 3K, FIG. 3L, FIG. 3M, FIG. 3N, FIG. 3O, FIG. 3P, FIG. 3Q, and FIG. 3R show a series of screenshots of the graphical user interface of one or more embodiments of the disclosure. The screenshots are presented in order of executed on the application. Different orders may exist depending on how the user scrolls through content in the user’s feed.

In the example, the user’s feed is a series of posts that are videos. The videos in the feed correspond to proposed matches by the matching algorithm, single directional matches, or bi-directional matches. At the bottom of each post in the user feed is user identifier information of the user that posted the video and a heart icon. The heart icon indicates whether the user has opted into the match. A red heart indicates that the user opted into the match. A filled white icon indicates that no match exists. Namely, the filled white icon indicates that the user has not yet opted into the match. The heart may change to a smaller heart when a bi-directional match exists. As shown in FIGS. 3A-3R users which are matched, bidirectionally or single directionally, are intermixed with users for which no match exists.

FIG. 3A show an example posting when a user opens the application. No match exists with the other user in the posting of FIG. 3A. The user scrolls as shown in FIG. 3B to the next posting in FIG. 3C without opting into the match. As shown in FIG. 3C, the user is a single directional match with the other user as indicated by the heart icon being solid red.

As shown in FIG. 3D, the user chooses to continue scrolling to the posting of FIG. 3E. When the full screen of the posting is displayed, the video of the posting automatically plays in one or more embodiments. The user is not a match with the other user that posted the video in FIG. 3E. The user continues scrolling as shown in FIG. 3F to the next posting. Scrolling may be in a forward and backward direction. For example, the user may scroll back as shown in FIG. 3G to the previous posting. When the user scrolls to the previous posting, the video of the previous posting is played as shown in FIG. 3H.

Selecting the heart icon creates a match with the other user that created the posting of FIG. 3H if the other user has also opted into the match. A celebration overlay is played as shown in FIG. 3I. The user may then select to send a direct message (DM) or perform other actions. Namely, full communication is authorized.

As shown in FIGS. 3J and 3K, consider the case in which the user selects to send a message. In one or more embodiments messages through the graphical user interface are point to point. Namely, any response message is presented only to the other user and not to all matches.

Thus, while certain content may be private content that is transmitted to all or a select portion of matches, commentary and other responsive communication is private and for a single user to which the commentary is directed in one or more embodiments.

Once the user completes the message, the message is sent to the other user and the user is reverted back to the feed view as shown in FIG. 3L. The user may continue scrolling as shown in FIG. 3M and FIG. 3N. Further, the user may opt into additional matches as shown in FIG. 3O.

The user may continue scrolling to bidirectional matches as shown in FIG. 3P. FIG. 3P shows an example interface with a bi-directional match. As shown in FIG. 3P, the bottom right heart icon changed to a “matched” indicator with a heart. Further, an user interface widget is displayed that allows the user to send a direct message. As shown in FIG. 3Q, when the user selects the widget, the user is presented with the ability to enter text. The user may enter the message. Then the user may continue scrolling through their feed as shown in FIG. 3R. As shown in FIG. 3R, the next video in the example is from a user to which the other user is not yet matched.

Embodiments of the present disclosure may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure. For example, as shown in FIG. 4A, the computing system (400) may include one or more computer processors (402), non-persistent storage (404) (e.g., volatile memory, such as random access memory (RAM), cache memory), persistent storage (406) (e.g., a hard disk, an optical drive such as a compact disk (CD) drive or digital versatile disk (DVD) drive, a flash memory, etc.), a communication interface (412) (e.g., Bluetooth interface, infrared interface, network interface, optical interface, etc.), and numerous other elements and functionalities that implement the features and elements of the disclosure.

The computer processor(s) (402) may be an integrated circuit for processing instructions. For example, the computer processor(s) may be one or more cores or micro-cores of a processor. The computing system (400) may also include one or more input devices (410), such as a touchscreen, keyboard, mouse, microphone, touchpad, electronic pen, or any other type of input device.

The communication interface (412) may include an integrated circuit for connecting the computing system (400) to a network (not shown) (e.g., a local area network (LAN), a wide area network (WAN) such as the Internet, mobile network, or any other type of network) and/or to another device, such as another computing device.

Further, the computing system (400) may include one or more output devices (408), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (402), non-persistent storage (404), and persistent storage (406). Many different types of computing systems exist, and the aforementioned input and output device(s) may take other forms.

Software instructions in the form of computer readable program code to perform embodiments of the present disclosure may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the present disclosure.

The computing system (400) in FIG. 4A may be connected to or be a part of a network. For example, as shown in FIG. 4B, the network (420) may include multiple nodes (e.g., node X (422), node Y (424)). Each node may correspond to a computing system, such as the computing system shown in FIG. 4A, or a group of nodes combined may correspond to the computing system shown in FIG. 4A. By way of an example, embodiments of the present disclosure may be implemented on a node of a distributed system that is connected to other nodes. By way of another example, embodiments of the present disclosure may be implemented on a distributed computing system having multiple nodes, where each portion of the present disclosure may be located on a different node within the distributed computing system. Further, one or more elements of the aforementioned computing system (400) may be located at a remote location and connected to the other elements over a network.

Although not shown in FIG. 4B, the node may correspond to a blade in a server chassis that is connected to other nodes via a backplane. By way of another example, the node may correspond to a server in a data center. By way of another example, the node may correspond to a computer processor or micro-core of a computer processor with shared memory and/or resources.

The nodes (e.g., node X (422), node Y (424)) in the network (420) may be configured to provide services for a client device (426). For example, the nodes may be part of a cloud computing system. The nodes may include functionality to receive requests from the client device (426) and transmit responses to the client device (426). The client device (426) may be a computing system, such as the computing system shown in FIG. 4A. Further, the client device (426) may include and/or perform all or a portion of one or more embodiments of the present disclosure.

The computing system or group of computing systems described in FIGS. 4A and 4B may include functionality to perform a variety of operations disclosed herein. For example, the computing system(s) may perform communication between processes on the same or different system. A variety of mechanisms, employing some form of active or passive communication, may facilitate the exchange of data between processes on the same device. Examples representative of these inter-process communications include, but are not limited to, the implementation of a file, a signal, a socket, a message queue, a pipeline, a semaphore, shared memory, message passing, and a memory-mapped file. Further details pertaining to a couple of these non-limiting examples are provided below.

Based on the client-server networking model, sockets may serve as interfaces or communication channel end-points enabling bidirectional data transfer between processes on the same device. Foremost, following the client-server networking model, a server process (e.g., a process that provides data) may create a first socket object. Next, the server process binds the first socket object, thereby associating the first socket object with a unique name and/or address. After creating and binding the first socket object, the server process then waits and listens for incoming connection requests from one or more client processes (e.g., processes that seek data). At this point, when a client process wishes to obtain data from a server process, the client process starts by creating a second socket object. The client process then proceeds to generate a connection request that includes at least the second socket object and the unique name and/or address associated with the first socket object. The client process then transmits the connection request to the server process. Depending on availability, the server process may accept the connection request, establishing a communication channel with the client process, or the server process, busy in handling other operations, may queue the connection request in a buffer until server process is ready. An established connection informs the client process that communications may commence. In response, the client process may generate a data request specifying the data that the client process wishes to obtain. The data request is subsequently transmitted to the server process. Upon receiving the data request, the server process analyzes the request and gathers the requested data. Finally, the server process then generates a reply including at least the requested data and transmits the reply to the client process. The data may be transferred, more commonly, as datagrams or a stream of characters (e.g., bytes).

Shared memory refers to the allocation of virtual memory space in order to substantiate a mechanism for which data may be communicated and/or accessed by multiple processes. In implementing shared memory, an initializing process first creates a shareable segment in persistent or non-persistent storage. Post creation, the initializing process then mounts the shareable segment, subsequently mapping the shareable segment into the address space associated with the initializing process. Following the mounting, the initializing process proceeds to identify and grant access permission to one or more authorized processes that may also write and read data to and from the shareable segment. Changes made to the data in the shareable segment by one process may immediately affect other processes, which are also linked to the shareable segment. Further, when one of the authorized processes accesses the shareable segment, the shareable segment maps to the address space of that authorized process. Often, only one authorized process may mount the shareable segment, other than the initializing process, at any given time.

Other techniques may be used to share data, such as the various data described in the present application, between processes without departing from the scope of the present disclosure. The processes may be part of the same or different application and may execute on the same or different computing system.

Rather than or in addition to sharing data between processes, the computing system performing one or more embodiments of the present disclosure may include functionality to receive data from a user. For example, in one or more embodiments, a user may submit data via a graphical user interface (GUI) on the user device. Data may be submitted via the graphical user interface by a user selecting one or more graphical user interface widgets or inserting text and other data into graphical user interface widgets using a touchpad, a keyboard, a mouse, or any other input device. In response to selecting a particular item, information regarding the particular item may be obtained from persistent or non-persistent storage by the computer processor. Upon selection of the item by the user, the contents of the obtained data regarding the particular item may be displayed on the user device in response to the user’s selection.

By way of another example, a request to obtain data regarding the particular item may be sent to a server operatively connected to the user device through a network. For example, the user may select a uniform resource locator (URL) link within a web client of the user device, thereby initiating a Hypertext Transfer Protocol (HTTP) or other protocol request being sent to the network host associated with the URL. In response to the request, the server may extract the data regarding the particular selected item and send the data to the device that initiated the request. Once the user device has received the data regarding the particular item, the contents of the received data regarding the particular item may be displayed on the user device in response to the user’s selection. Further to the above example, the data received from the server after selecting the URL link may provide a web page in Hyper Text Markup Language (HTML) that may be rendered by the web client and displayed on the user device.

Once data is obtained, such as by using techniques described above or from storage, the computing system, in performing one or more embodiments of the present disclosure, may extract one or more data items from the obtained data. For example, the extraction may be performed as follows by the computing system in FIG. 4A. First, the organizing pattern (e.g., grammar, schema, layout) of the data is determined, which may be based on one or more of the following: position (e.g., bit or column position, Nth token in a data stream, etc.), attribute (where the attribute is associated with one or more values), or a hierarchical/tree structure (consisting of layers of nodes at different levels of detail-such as in nested packet headers or nested document sections). Then, the raw, unprocessed stream of data symbols is parsed, in the context of the organizing pattern, into a stream (or layered structure) of tokens (where each token may have an associated token “type”).

Next, extraction criteria are used to extract one or more data items from the token stream or structure, where the extraction criteria are processed according to the organizing pattern to extract one or more tokens (or nodes from a layered structure). For position-based data, the token(s) at the position(s) identified by the extraction criteria are extracted. For attribute/value-based data, the token(s) and/or node(s) associated with the attribute(s) satisfying the extraction criteria are extracted. For hierarchical/layered data, the token(s) associated with the node(s) matching the extraction criteria are extracted. The extraction criteria may be as simple as an identifier string or may be a query presented to a structured data repository (where the data repository may be organized according to a database schema or data format, such as XML).

The extracted data may be used for further processing by the computing system. For example, the computing system of FIG. 4A, while performing one or more embodiments of the present disclosure, may perform data comparison. Data comparison may be used to compare two or more data values (e.g., A, B). For example, one or more embodiments may determine whether A > B, A = B, A != B, A < B, etc. The comparison may be performed by submitting A, B, and an opcode specifying an operation related to the comparison into an arithmetic logic unit (ALU) (i.e., circuitry that performs arithmetic and/or bitwise logical operations on the two data values). The ALU outputs the numerical result of the operation and/or one or more status flags related to the numerical result. For example, the status flags may indicate whether the numerical result is a positive number, a negative number, zero, etc. By selecting the proper opcode and then reading the numerical results and/or status flags, the comparison may be executed. For example, in order to determine if A > B, B may be subtracted from A (i.e., A - B), and the status flags may be read to determine if the result is positive (i.e., if A > B, then A - B > 0). In one or more embodiments, B may be considered a threshold, and A is deemed to satisfy the threshold if A = B or if A > B, as determined using the ALU. In one or more embodiments of the present disclosure, A and B may be vectors, and comparing A with B requires comparing the first element of vector A with the first element of vector B, the second element of vector A with the second element of vector B, etc. In one or more embodiments, if A and B are strings, the binary values of the strings may be compared.

The computing system in FIG. 4A may implement and/or be connected to a data repository. For example, one type of data repository is a database. A database is a collection of information configured for ease of data retrieval, modification, re-organization, and deletion. Database Management System (DBMS) is a software application that provides an interface for users to define, create, query, update, or administer databases.

The user, or software application, may submit a statement or query into the databaseMS. Then the databaseMS interprets the statement. The statement may be a select statement to request information, update statement, create statement, delete statement, etc. Moreover, the statement may include parameters that specify data, data containers (database, table, record, column, view, etc.), identifiers, conditions (comparison operators), functions (e.g. join, full join, count, average, etc.), sorts (e.g. ascending, descending), or others. The databaseMS may execute the statement. For example, the databaseMS may access a memory buffer, a reference or index a file for read, write, deletion, or any combination thereof, for responding to the statement. The databaseMS may load the data from persistent or non-persistent storage and perform computations to respond to the query. The databaseMS may return the result(s) to the user or software application.

The computing system of FIG. 4A may include functionality to present raw and/or processed data, such as results of comparisons and other processing. For example, presenting data may be accomplished through various presenting methods. Specifically, data may be presented through a user interface provided by a computing device. The user interface may include a GUI that displays information on a display device, such as a computer monitor or a touchscreen on a handheld computer device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

For example, a GUI may first obtain a notification from a software application requesting that a particular data object be presented within the GUI. Next, the GUI may determine a data object type associated with the particular data object, e.g., by obtaining data from a data attribute within the data object that identifies the data object type. Then, the GUI may determine any rules designated for displaying that data object type, e.g., rules specified by a software framework for a data object class or according to any local parameters defined by the GUI for presenting that data object type. Finally, the GUI may obtain data values from the particular data object and render a visual representation of the data values within a display device according to the designated rules for that data object type.

Data may also be presented through various audio methods. In particular, data may be rendered into an audio format and presented as sound through one or more speakers operably connected to a computing device.

Data may also be presented to a user through haptic methods. For example, haptic methods may include vibrations or other physical signals generated by the computing system. For example, data may be presented to a user using a vibration generated by a handheld computer device with a predefined duration and intensity of the vibration to communicate the data.

The above description of functions presents only a few examples of functions performed by the computing system of FIG. 4A and the nodes and/ or client device in FIG. 4B. Other functions may be performed using one or more embodiments of the present disclosure.

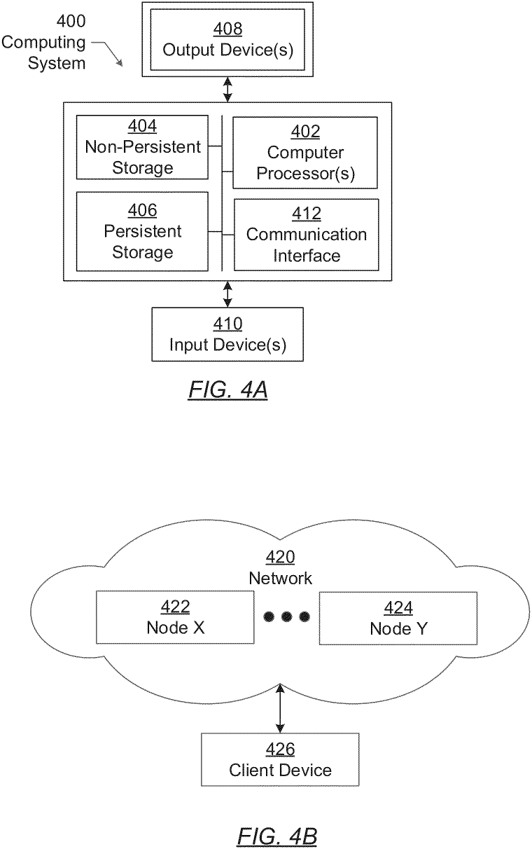

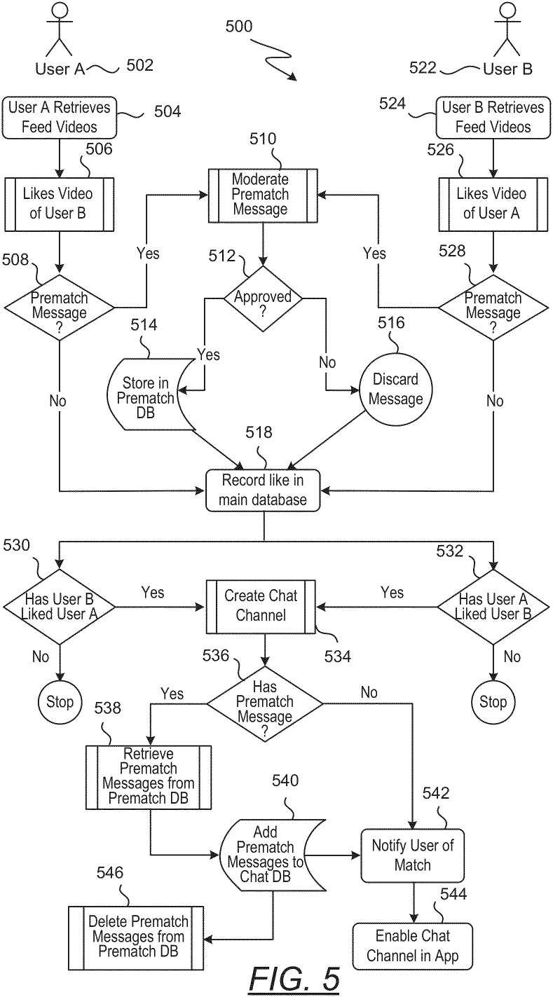

FIGS. 4A and 4B illustrate example computer systems for implementing the techniques and mechanisms disclosed herein. FIG. 5 is flow chart of an example method that can be performed using a computer system, such as the ones shown in FIGS. 4A and 4B. Method 500 starts with User A 502 retrieving, at 504, feed videos. In some embodiments, once an individual user, such as User A 502, opens the social networking application, the user gets to the main feed view, which then causes an API call to a backend server to call up videos to the feed. In some embodiments, this is accomplished using a feed logic algorithm, such as the one described below.

One example of a feed logic algorithm starts with the user first setting up preferences. In some embodiments, a user has fixed preferences for age and gender. In some embodiments, users also have a fixed country group (e.g., Canada only sees other users from their country grouping). In some embodiments, a user also has flexible preferences for distance (this is taken into account for some parts of the feed but is ignored in other parts depending on circumstances). In some embodiments, users can also set hard filters, which prevent videos that the user does not want to see. In some embodiments, soft filters also come into play. These filters can be set by users, but can also be set automatically in the backend server in order to prevent the user from seeing the same video content within a certain period of time, e.g., 72 hours. In some embodiments, different factors contribute to a score for a particular user. User scores affect their visibility in other users’ feeds. Certain reported actions may lower someone’s score. For example, if a user has been reported as being “ghoster,” where they stop communicating for whatever reason, that user’s score is dinged.

Based on the above, a user can get view a feed of other user’s content. For example, a user can get videos within set preferences, filtering out seen videos from profiles who have logged on in last 7 days, within 60 km of the user’s location, and have received either more than 5 total likes or more than 10 total likes. In some embodiments, if there are fewer than 2 matches based on these criteria, then the same query is run again, but this time within 158 km.

In some embodiments, the feed only retrieves content from users who have logged on in the last 2 weeks, within fixed preferences with all filters applied, and within ~60 km range. In such embodiments, this is regardless of whatever is set for the users distance preference. If there are more than 20 results, the system grabs the most recently logged in users first. In some embodiments, if there are fewer than 20 results from above, the same query is run again with preferences and filters but getting users that have logged on in the last 300 days and within 200 km range. According to various embodiments, re-running the algorithms with expanded distances and longer time frames ensures enough content is sent to a user’s video feed.

In some embodiments, if a user has been liked, or requested to opt in to communicate, by other profiles who have videos not yet seen by the user, then the system quietly inserts a certain predetermined threshold number (e.g., 3) of videos from the different profiles that match user preferences and all filters and have liked the user. In such embodiments, the system still takes into account user distance preference.

In some embodiments, if a user has been liked via message or liked, by other profiles who have videos that have not yet been filtered out and who are within fixed preferences, then the user will get at least one video, within the user’s preferences, from someone who liked the user via message or content.

Returning now to FIG. 5, User A 502 can either like a video, for example a video by User B 522 at step 506, or not like the video. In some embodiments, User A 502 can either like that video by User B 522 by either tapping a “like” button or sending a pre-match message associated with that video. At 508, the system determines whether there was a pre-match message attached to the like. If there is a pre-match message, then the system sends that message to moderation (510) to check for flagged content, such as hate speech, violence, bullying, sexual content, etc. At 512, the message is approved or not approved. If that message is approved, the system stores (514) the message in a separate collection database. In some embodiments, this separate collection database is a pre-match storage database. If the message is not approved at 512, then the message is discarded (516).

In some embodiments, if there is no pre-match message 508, then the like 506 is stored in a main database 518, which is separate from the pre-match storage database. The main database is separate from the pre-match storage database in order to allow scaling. In some embodiments, pre-match messages are counted as implicit likes, and thus, even if the pre-match message is discarded because it does not pass approval during moderation, the implicit like is stored in the main database at 518.

In some embodiments, in order to create a match for communication, User B 522 must independently go through an analogous process. For example, User B 522 must retrieve (524) vides from their video feed. If User B 522 comes across a video by User A 502, and likes (526) the video, then the like is stored (518) in the main database. If the like included a pre-match message 528, then the message is also sent to moderation 510. If it is approved at 512, then it is stored in the pre-match database 514. If not, then it is discarded at 516.

According to various embodiments, the criteria for determining a match is whether User B has like User A (530) and whether User A has liked User B (532). As mentioned above, neither user is aware of whether the other user has liked their content until a match is actually recorded at 518. Once a match is recorded, a chat channel is created at 534. In some embodiments, this is accomplished by having the main backend server reach out to a chat backend server and create the channel dynamically by opening up a communication channel and layering a graphical user interface on both users’ sides. In some embodiments, the communication channel is implemented as a newly created document. This is because, for real time communications, they system must create websocket connections between the two users. That way, chat shows up instantaneously as it is being typed. This removes scaling issues related to managing websocket connections between users. In some embodiments, after the communication channel is created, the system will go check if there are any pre-match messages stored in the pre-match database. If so, the system will get those pre-match messages and populate the communication channel, via a GUI chat window, automatically. In addition, the video content liked by each user is also automatically inserted into the communication channel. This provides context for each user regarding which videos sparked the like.

In terms of front end implementation, the communication channel is created by first establishing a main database connection to a chat database server. The system then creates a connection between the chat server and an app on the device of each user. Each user in the channel is then allowed to see everything that is going on in the channel. Once a connection is established, a new record or document is written into that connection, or a portion of a table in the database. When a new record is inserted, then the chat server sends a notification of that document to the apps on each user device. Then the system figures out who was the message from and displays it to both users.

Returning to FIG. 5, once chat channel 534 is created, the system checks (536) for any pre-match messages. If there are pre-match message, the system will retrieve (538) them from the pre-match database, and add the messages (540), or migrate them, to the main chat database. Then, at 542, the system notifies both users of a new match, and at that point, the chat channel is enabled (544) in the app. Thus, each user can now see the new channel in their main chat screen. In some embodiments, after the system completes the pre-match migration, the system deletes (546) all the pre-match messages migrated over from the pre-match database in order to free up storage space.

In some embodiments, the main backend server stores all profile info for users, as well as some of the content, e.g., if there is a description of an uploaded video, and the asset IDs. In some embodiments, the actual video files are stored in a separate database in order to allow for scaling, due to the large size of videos. This allows videos to be streamed in the video feeds, thereby eliminating download and buffer times.

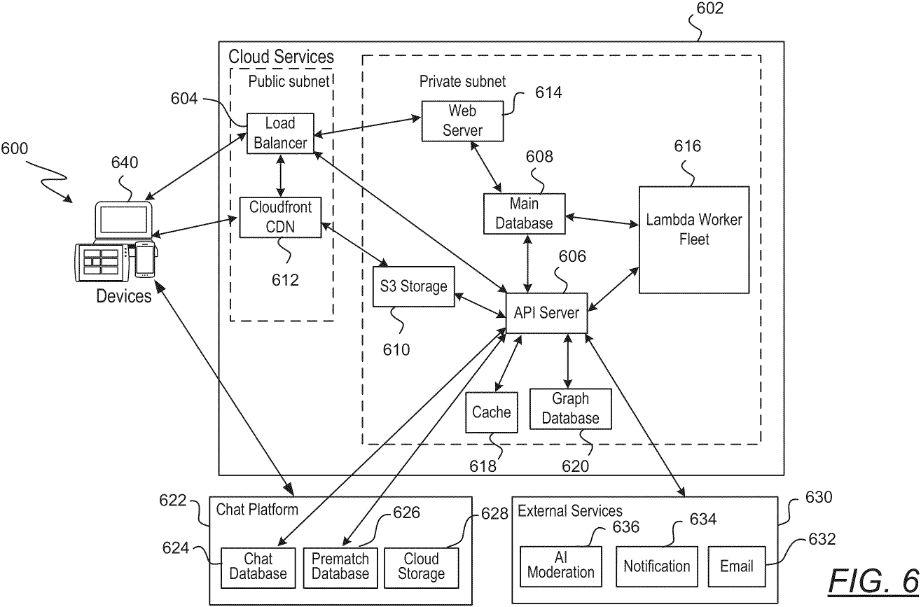

FIG. 5 showed an example method for implementing double blind opt in. FIG. 6 illustrates a high level system architecture that can be used to implement method 500. System 600 includes devices 640, which are used by individual users on the app. From the user’s POV, all interactions are performed via devices 640 through an interface connected to the services provided on the backend. In some embodiments, any time a device 640 interacts with the application platform, an API call is sent to a load balancer 604 in cloud services 602, which is publicly facing. A website running on a web server 614 is connected to the load balancer 604. In some embodiments, all API calls go through load balancer 604. What the load balancer 604 does is make sure that API calls are distributed to all the different backend instances. Depending on current load, the system might run more than one instance of web server 614, e.g., there might be five in flight and or only one if the load is light. The load balancer figures out which resource is not busy and then sends a call there.

In some embodiments, API calls go directly from the device to load balancer, and the load balancer 604 decides which instance of servers is handling the API call, and then goes straight to API server 606. In some embodiments, there can be multiple instances of API server 606.

In some embodiments, all information outside of chat is stored in a main database 608, which may act as a single source of truth. In some embodiments, API server 606 is then responsible for all the crowd operations, e.g., creating new records and updating or deleting information. However, in some embodiments, profile images are stored in S3 storage 610 because image files can be large and numerous.

According to various embodiments, all the API calls modify information in one way or another, which is stored in the main database 608.

In some embodiments, while images are stored on S3 storage 610, they are subsequently sent to cloudfront CDN 612 for distribution. This is because images are in general bigger files. Due to their large size, the system needs to serve the images geographically as close as possible to the user. In such embodiments, cloudfront CDN 612 distributes images out to multiple data centers across the world to maximize image distribution efficiency.

In some embodiments, there may be cases where the system needs to redirect web content. In some embodiments, typically, web content is embedded in web server 614, but there are some data that is allowed to be changed more frequently. In such embodiments, web server 614 goes through load balancer 604 because there might be more than one instance of web server 614. In some embodiments, web server 614 is located in the private subnet because some pages show useful information, such as the most used hashtags on the platform, which can be useful, for example, for search engine optimization (SEO) purposes.

According to various embodiments, the private subnet also includes lambda workfleet 616. In some embodiments, lambda workfleet 616 comprises individual serverless workers that perform various maintenance tasks, e.g., changing profile pictures, performing analytics work, cleaning up databases, finding orphan assets or pictures, and other various maintenance items.

In some embodiments, private subnet also includes cache 618. In such embodiments, API server 606 uses in-memory cache 618, for information that is very frequently accessed. An example is when a user scrolls through a feed you and puts hashtags on the profile. The system will store the hashtag in cache 618 because hashtags are accessed everywhere and cache is faster than making database queries, especially if a database joins across multiple tables. In such embodiments, frequently accessed information that is expensive to obtain, is stored in cache 618 and is read directly from memory.

In some embodiments, cache 618 is also used to filter out feed content. Because cache has time based expiration, video content shown can be stored in cache with an expiration. The feed algorithm can then be modified to not show any video content that is still located in cache 618.

In some embodiments, private subnet also includes graph database 620. Graph database 620 is used to track a user’s social brand, how many connections between the user and other people, as well as the kind of connections between the user and other people.

As shown in FIG. 6, system architecture 600 also includes chat platform 622 and external services 630. In some embodiments, the system stores most of the chat data in chat platform 622. In some embodiments, chat platform 622 is also a cloud based platform. In some embodiments, chat platform 622 includes a chat database 624, which stores all messages in a chat channel. In some embodiments, chat platform 622 also includes a pre-match database 626 for storing pre-match messages. Chat platform 622 also includes cloud storage 628 to store any images or videos that users send to each other directly in the chat. In such embodiments, because the videos and images are sent directly, it does not go through the system’s main video hosting platform. As used herein, the terms “server” and “database” can be used interchangeably because each database will have some basic functions and operations processing.

As shown in FIG. 6, external services 630 is used to handle various different aspects of a social network application. AI moderation service 636, is utilized to handle everything that needs moderation, such as pre-match messages, video content, and images. Notification service 634 is used anytime the system wants to send a user a push notification. Email service 632 handles all email related services.

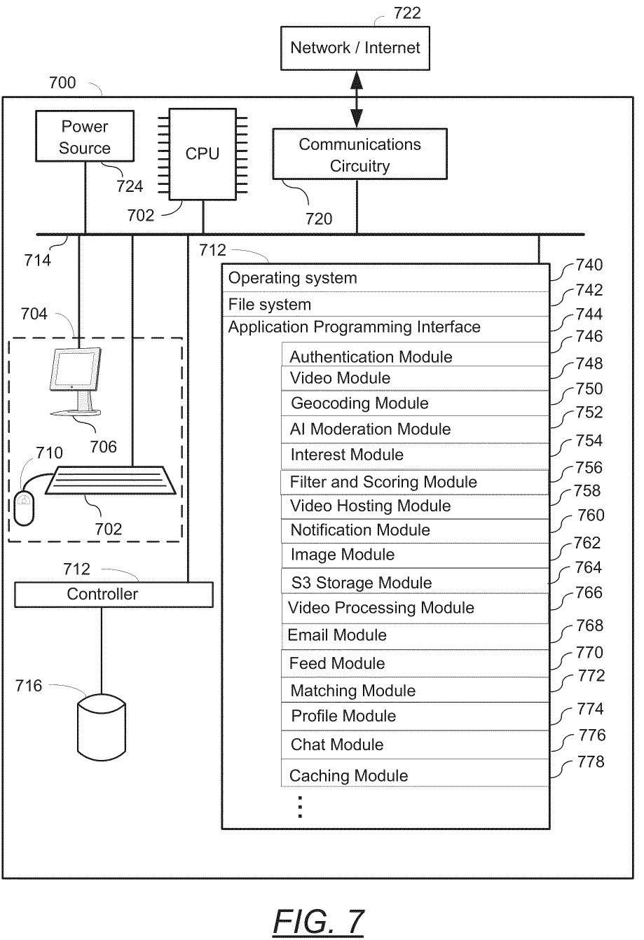

FIG. 6 shows an example high level system architecture for implementing the techniques and mechanisms disclosed herein. FIG. 7 is an example software architecture that can be used to implement the systems and methods described in the present disclosure.

FIG. 7 is a block diagram illustrating an example of a computer system capable of implementing various processes described in the present disclosure. The system 700 typically includes a power source 724; one or more processing units (CPU’s) 702 for executing modules, programs and/or instructions stored in memory 712 and thereby performing processing operations; one or more network or other communications circuitry or interfaces 720 for communicating with a network 722; controller 712; and one or more communication buses 714 for interconnecting these components. In some embodiments, network 722 can be another communication bus, the Internet, an Ethernet, an Intranet, other wide area networks, local area networks, and metropolitan area networks. Communication buses 714 optionally include circuitry (sometimes called a chipset) that interconnects and controls communications between system components. According to various embodiments, system 700 uses a controller-service-repository architecture. Once an API call is made, it hits controller 712, controller 712 then decodes the information and passes it on to the appropriate service module with the business logic to can accomplish its specific task. If there is anything that needs to be stored in the database, controller 712 passes the data to a repository, which interfaces with the database.

System 700 optionally includes a user interface 704 comprising a display device 706, a keyboard 708, and a mouse 710. In addition, system 700 includes camera 726, which may or may not be a webcam or a built-in computer camera. Memory 712 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 712 may optionally include one or more storage devices 716 remotely located from the CPU(s) 702. Memory 712, or alternately the non-volatile memory device(s) within memory 712, comprises a non-transitory computer readable storage medium. In some embodiments, memory 712, or the computer readable storage medium of memory 712 stores the following programs, modules and data structures, or a subset thereof:
an operating system 740 that includes procedures for handling various basic system services and for performing hardware dependent tasks;
a file system 744 for storing various program files; and
an application programming interface 744 for implementing software functions.

Application Programming Interface 744 may also include the following submodules, or a subset thereof:
Authentication Module 746 for providing authentication and authorization for API calls. Authentication Module 746 is responsible for creating, validating and refreshing access tokens when a user requests access to the platform. In addition, Authentication Module 746 uses information about the user’s device to determine if a user should be allowed back onto the platform;
Video Module 748 for handling all processing related to handling videos. Video Module 748 manages the creation, update and deletion of any records related to individual videos uploaded to the platform;
Geocoding Module 750 for mapping latitude and longitude coordinates obtained from end user devices. When latitude/longitude coordinates are updated Geocoding Module 750 reverse geocodes the coordinates to a city, region (state/province) and country that is displayed to end users. In addition to the reverse geocoding, Geocoding Module 750 also encodes the coordinates to hexagonal, hierarchical indexes that are then used instead of the coordinates to determine how close users are to each other during feed requests;
AI Moderation Module 752 for submitting all user generated content to an external service provider for automated moderation;
Interest Module 754 for managing hashtags users can put on their profile. Interest Module 754 maintains the relationships between users and hashtags and determines which hashtags are recommended to users or should be hidden based on their moderation status. In addition, Interest Module 754 provides search functionality to enable users to find appropriate hashtags;
Filter and Scoring Module 756 for scoring the classifications provided by AI Moderation Module 752 and categorizing them based on an internal rule set. Each moderation response is assigned a score based on the classification of the content which is then added to the users profile which determines if the user is uploading unacceptable content. This trust score is used to determine if the user should be able to continue as a regular user, put into limbo (which prevents them from interacting with other users) or should be outright banned from the platform;
Video Hosting Module 758 for submitting new uploaded videos to an external hosting provider for video streaming distribution. Video Hosting Module 758 processes the responses from the provider and determines the physical aspects of the video (dimensions, orientation, file size, audio, etc) which is used by the app to determine how a video should be displayed;
Notification Module 760 for sending push notifications to end user devices based on the activities of the user on the platform;
Image Module 762 for managing user profile pictures on the platform. Image Module 762 sends images to AI Moderation Module 752 and then takes the results from Filter and Scoring Module 756 and subsequently instructs S3 Storage Module 764 to move image files to the appropriate bucket based on the results;
S3 Storage Module 764 for managing files across the various storage buckets and provides functionality to delete or move them as appropriate. For example, when a user first uploads a profile image it is added to the upload bucket. When the upload completes, the image is moved to a review bucket and is submitted to AI Moderation Module 752. If the image is approved, it is moved to a distribution bucket that makes it available to external users via a CDN;
Video Processing Module 766 for coordinating all of the results from AI Moderation Module 752 and other internal moderation processes. The primary responsibility of Video Processing Module 766 is to aggregate all of the processing results related to videos and determine if the video should be visible to the feed service;
Email Module 768 for sending emails to users via an external provider;
Feed Module 770 for calculating the videos to show to users in the main video feed of the application. Feed Module 770 determines the videos that should be shown to the user based on their preferences, interests and corresponding data from other users. Feed Module 770 is also responsible for making sure a user sees others in their feed that have liked them or who they are already matched. Feed Module 770 uses the cache service to exclude videos the user has already seen in the last 3 days (or users they have seen in the last 20 minutes);
Matching Module 772 for managing matches between users based on their reactions to videos. Matching Module 772 is responsible for managing the double blind opt in process, creating chat channels and migrating any pre-match messages for the users from pre-match database to the main chat database;
Profile Module 774 for managing the users’ profile information, thereby allowing them to update preferences, interests, and any other information tied to the user;
Chat Module 776 for connecting users to a communication channel after they have matched via the double blind opt in process. Chat Module 776 maintains the chat channels and uses the various moderation services to help users remain safe on the platform; and
Caching Module 778 for allowing other services to store and retrieve frequently used information to an in memory cache to speed up various aspects of the experience..

Each of the above identified elements may be stored in one or more of the previously mentioned memory devices, and corresponds to a set of instructions for performing a function described above. The above identified modules or programs (i.e., sets of instructions) need not be implemented as separate software programs, procedures or modules, and thus various subsets of these modules may be combined or otherwise re-arranged in various embodiments. In some embodiments, memory 712 may store a subset of the modules and data structures identified above. Furthermore, memory 712 may store additional modules and data structures not described above.

Although FIG. 7 shows a “social networking system,” FIG. 7 is intended more as functional description of the various features which may be present in a set of servers than as a structural schematic of the embodiments described herein. In practice, and as recognized by those of ordinary skill in the art, items shown separately could be combined and some items could be separated. For example, some items shown separately in FIG. 7 could be implemented on single servers and single items could be implemented by one or more servers. The actual number of servers used to implement a social networking system and how features are allocated among them will vary from one implementation to another, and may depend in part on the amount of data traffic that the system must handle during peak usage periods as well as during average usage periods.

According to various embodiments, the system includes software that implements a graphical user interface that allows students to take machine monitored tests and for teachers to use the results of the monitoring to analyze the student’s performance. Similarly the system will incorporate software that presents the monitored factors and results in a format using graphical displays.

Because such information and program instructions may be employed to implement the systems/methods described herein, the present disclosure relates to tangible, machine readable media that include program instructions, state information, etc. for performing various operations described herein. Examples of machine-readable media include hard disks, floppy disks, magnetic tape, optical media such as CD-ROM disks and DVDs; magneto-optical media such as optical disks, and hardware devices that are specially configured to store and perform program instructions, such as read-only memory devices (ROM) and programmable read-only memory devices (PROMs). Examples of program instructions include both machine code, such as produced by a compiler, and files containing higher level code that may be executed by the computer using an interpreter.

Although many of the components and processes are described above in the singular for convenience, it will be appreciated by one of skill in the art that multiple components and repeated processes can also be used to practice the techniques of the present disclosure.

While the present disclosure has been particularly shown and described with reference to specific embodiments thereof, it will be understood by those skilled in the art that changes in the form and details of the disclosed embodiments may be made without departing from the spirit or scope of the disclosure. It is therefore intended that the disclosure be interpreted to include all variations and equivalents that fall within the true spirit and scope of the present disclosure.

What is claimed is:

1. A method comprising:
determining, by a social network application, a potential match between a first user and a second user;
displaying content from the first user to the second user and content from the second user to the first user, wherein displaying content includes inserting the content into a content feed of a user;
receiving in a graphical user interface of the social network application a request by the first user to opt in to communicate with the second user;
storing the request by the first user in a database such that the second user is not notified about, and cannot see, the request by the first user;
recording a match only if the second user independently requests to opt in to communicate with the first user without knowing that the first user has also requested to communicate with the second user, wherein the first user also is not notified if the second user opts in to communicate with the first user before the first user opts in to communicate with the second user; and
creating a communication channel between the first user and the second user via the graphical user interface, wherein the communication channel is not created until after both the first user and the second user opt in to communicate with each other.

2. The method of claim 1, wherein the request by the first user or the request by the second user includes a pre-match message, the pre-match message being stored in a separate database and displayed in the communication channel only if a match is recorded.

3. The method of claim 1, wherein both the first and second user uploads video content to be shown in other users’ feeds.

4. The method of claim 1, wherein any content uploaded or messages sent are moderated before being displayed.

5. The method of claim 1, wherein a particular user’s content feed includes content of other users that have opted in to communicate with that particular user but the particular user is not notified and cannot see who has opted in to communicate with the particular user.

6. The method of claim 1, wherein a request to opt in is correlated with a certain piece of video content, and after a match is a recorded, the certain piece of content is automatically uploaded into the communication channel.

7. The method of claim 1, wherein a user’s feed is filtered by preferences of the user.

8. A system comprising:
one or more processors; and
memory, the memory storing instructions to cause the processors to execute a method, the method comprising:
determining, by a social network application, a potential match between a first user and a second user;
displaying content from the first user to the second user and content from the second user to the first user, wherein displaying content includes inserting the content into a content feed of a user;
receiving in a graphical user interface of the social network application a request by the first user to opt in to communicate with the second user;
storing the request by the first user in a database such that the second user is not notified about, and cannot see, the request by the first user;
recording a match only if the second user independently requests to opt in to communicate with the first user without knowing that the first user has also requested to communicate with the second user, wherein the first user also is not notified if the second user opts in to communicate with the first user before the first user opts in to communicate with the second user; and
creating a communication channel between the first user and the second user via the graphical user interface, wherein the communication channel is not created until after both the first user and the second user opt in to communicate with each other.

9. The system of claim 8, wherein the request by the first user or the request by the second user includes a pre-match message, the pre-match message being stored in a separate database and displayed in the communication channel only if a match is recorded.

10. The system of claim 8, wherein both the first and second user uploads video content to be shown in other users’ feeds.

11. The system of claim 8, wherein any content uploaded or messages sent are moderated before being displayed.

12. The system of claim 8, wherein a particular user’s content feed includes content of other users that have opted in to communicate with that particular user but the particular user is not notified and cannot see who has opted in to communicate with the particular user.

13. The system of claim 8, wherein a request to opt in is correlated with a certain piece of video content, and after a match is a recorded, the certain piece of content is automatically uploaded into the communication channel.

14. The system of claim 8, wherein a user’s feed is filtered by preferences of the user.

15. A non-transitory computer readable medium storing instructions to cause one or more processors to execute a method, the method comprising:
determining, by a social network application, a potential match between a first user and a second user;
displaying content from the first user to the second user and content from the second user to the first user, wherein displaying content includes inserting the content into a content feed of a user;
receiving in a graphical user interface of the social network application a request by the first user to opt in to communicate with the second user;
storing the request by the first user in a database such that the second user is not notified about, and cannot see, the request by the first user;
recording a match only if the second user independently requests to opt in to communicate with the first user without knowing that the first user has also requested to communicate with the second user, wherein the first user also is not notified if the second user opts in to communicate with the first user before the first user opts in to communicate with the second user; and
creating a communication channel between the first user and the second user via the graphical user interface, wherein the communication channel is not created until after both the first user and the second user opt in to communicate with each other.

16. The non-transitory computer readable medium of claim 15, wherein the request by the first user or the request by the second user includes a pre-match message, the pre-match message being stored in a separate database and displayed in the communication channel only if a match is recorded.

17. The non-transitory computer readable medium of claim 15, wherein both the first and second user uploads video content to be shown in other users’ feeds.

18. The non-transitory computer readable medium of claim 15, wherein any content uploaded or messages sent are moderated before being displayed.

19. The non-transitory computer readable medium of claim 15, wherein a particular user’s content feed includes content of other users that have opted in to communicate with that particular user but the particular user is not notified and cannot see who has opted in to communicate with the particular user.

20. The non-transitory computer readable medium of claim 15, wherein a request to opt in is correlated with a certain piece of video content, and after a match is a recorded, the certain piece of content is automatically uploaded into the communication channel.
